(19) United States
(12) Patent Application Publication
(10) Pub. No.: US 2011/0077823 A1
(43) Pub. Date: Mar. 31, 2011

(54) STEERING CONTROL DEVICE FOR A VEHICLE

(75) Inventor: Norihisa Nishikawa, Shizuoka-ken (JP)

(73) Assignee: Toyota Jidosha Kabushiki Kaisha, Toyota-shi (JP)

(21) Appl. No.: 12/996,586

(22) PCT Filed: Mar. 3, 2009
(86) PCT No.: PCT/JP09/53926

§ 371 Date: Dec. 6, 2010

(51) Int. Cl. B62D 6/00

(52) U.S. Cl. 701/41

(57) ABSTRACT

A steering control device for a vehicle independently performs a steering control of front wheels and rear wheels. A phase control unit performs a control of a steering control unit so as to control a phase difference between a yaw rate and a lateral acceleration at a predetermined position in a vehicle interior. Additionally, a setting unit sets the predetermined position based on a riding position condition of passengers in the vehicle interior. Therefore, it is possible to appropriately control the phase difference between the yaw rate and the lateral acceleration at the predetermined position in the vehicle interior. So, it becomes possible to appropriately ensure a comfort (ride quality) of the passenger at the predetermined position.

### TECHNICAL FIELD

The present invention relates to a steering control device for a vehicle which independently controls a steering angle of front wheels and a steering angle of rear wheels.

### BACKGROUND TECHNIQUE

This kind of technique is proposed in Patent References 1 to 3, for example. In Patent Reference-1, as for the vehicle on which the four-wheel steering control device is mounted, there is proposed that the steering angle of the rear wheels is corrected by performing the feedback of the detected yaw rate and the lateral acceleration is controlled. In Patent Reference-2, as for the four-wheel steering control device, there is proposed that the yaw rate and the lateral acceleration are detected and the steering angle of the rear wheels is controlled in accordance with the magnitude of the lateral acceleration. In Patent Reference-3, as for the four-wheel steering control device, there is proposed the technique in which the driver can freely select whether the lateral acceleration response control by the rear wheel control or the yaw rate response control is prioritized.

Additionally, there are disclosed techniques related to the present invention in Patent References 4 and 5.
Patent Reference-1: Japanese Patent Application Laid-open under No. H5-85383
Patent Reference-2: Japanese Patent Application Laid-open under No. H5-105101
Patent Reference-3: Japanese Patent Application Laid-open under No. H6-99831
Patent Reference-4: Japanese Patent Application Laid-open under No. 2004-243813
Patent Reference-5: Japanese Patent Application Laid-open under No. 2008-129948

### DISCLOSURE OF INVENTION

### Problem to be Solved by the Invention

However, in the above Patent References 1 to 5, there is not disclosed that the steering control is performed in consideration of a phase difference between the yaw rate and the lateral acceleration in an appropriate manner. In addition, though the phase difference between the yaw rate and the lateral acceleration tends to be different between the driver seat and the rear seat, the techniques disclosed in the Patent References 1 to 5 do not consider how to deal with it.

The present invention has been achieved in order to solve the above problem. It is an object of this invention to provide a steering control device for a vehicle capable of ensuring a passenger comfort by appropriately controlling a phase difference between a yaw rate and a lateral acceleration at a predetermined position in a vehicle interior.

### Means for Solving the Problem

According to one aspect of the present invention, there is provided a steering control device for a vehicle including: a steering control unit which independently performs a steering control of front wheels and rear wheels; a phase control unit which performs a control of the steering control unit so as to control a phase difference between a yaw rate and a lateral acceleration at a predetermined position in a vehicle interior; and a setting unit which sets the predetermined position based on a riding position condition of passengers in the vehicle interior.

The above steering control device for the vehicle independently performs the steering control of the front wheels and the rear wheels by the steering control unit. The phase control unit performs the control of the steering control unit so as to control the phase difference between the yaw rate and the lateral acceleration at the predetermined position in the vehicle interior. Additionally, the setting unit sets the predetermined position based on the riding position condition of the passengers in the vehicle interior. By the above steering control device for the vehicle, it is possible to appropriately control the phase difference between the yaw rate and the lateral acceleration at the predetermined position in the vehicle interior. Therefore, it becomes possible to appropriately ensure the comfort (ride quality) of the passenger at the predetermined position.

In a manner of the above steering control device for the vehicle, the phase control unit performs the control so that a phase of the lateral acceleration precedes a phase of the yaw rate at the predetermined position.

According to the manner, it becomes possible to effectively ensure the comfort of the passenger at the predetermined position.

In another manner of the above steering control device for the vehicle, the setting unit obtains a presence or absence of the passenger on a rear seat as the riding position condition, and the setting unit sets the predetermined position to the rear seat side when the passenger is present on the rear seat, and sets the predetermined position to a front seat side when the passenger is not present on the rear seat.

According to the manner, it is possible to appropriately determine the predetermined position, where the relationship (phase difference) between the lateral acceleration and the yaw rate is prioritized, based on the presence or absence of the passenger on the rear seat, and it becomes possible to appropriately ensure the comfort of the passenger at the predetermined position. Therefore, when the passenger is present on the rear seat, for example, it becomes possible to appropriately ensure the comfort of the passenger on the rear seat.

In another manner of the above steering control device for the vehicle, the setting unit sets the predetermined position based on a setting condition of a switch in the vehicle interior by an operation of a driver.

According to the manner, it is possible to appropriately determine the predetermined position, where the relationship (phase difference) between the lateral acceleration and the yaw rate is prioritized, based on the setting by the driver, and it becomes possible to appropriately ensure the comfort of the passenger at the predetermined position.

In a preferred example of the above steering control device for the vehicle, when a vehicle speed is equal to or smaller than a predetermined speed, the phase control unit can control the phase difference.

### BRIEF DESCRIPTION OF THE DRAWINGS

FIG. 1 is a schematic diagram showing a configuration of a vehicle to which a steering control device for a vehicle according to an embodiment is applied;

FIGS. 2A to 2C are diagrams showing examples of a phase difference between a lateral acceleration and a yaw rate;

FIG. 3 is a flow chart showing a control process according to a first embodiment;

FIG. 4 is a flow chart showing a control process according to a second embodiment; and

FIG. 5 is a flow chart showing a control process according to a third embodiment.

### BRIEF DESCRIPTION OF THE REFERENCE NUMBER

1 Engine
2f Front wheels
2r Rear wheels
4 Handle (Steering wheel)
5 Handle (Steering wheel) angle sensor
6 Vehicle speed sensor
7f Front wheel steer actuator
7r Rear wheel steer actuator
10 System controller

### DETAILED DESCRIPTION OF THE PREFERRED EMBODIMENTS

A preferred embodiment of the present invention will be explained hereinafter with reference to the drawings.

### [Vehicle Configuration]

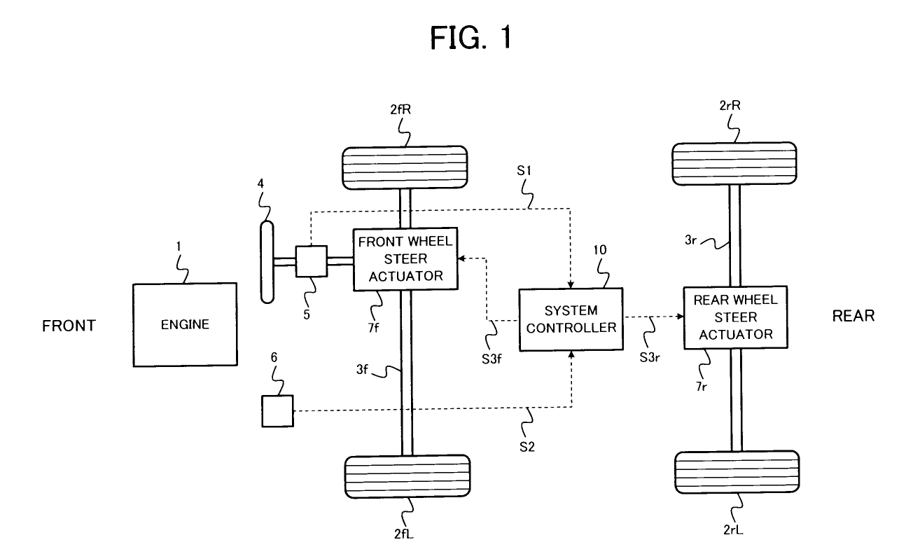

First, a description will be given of an entire configuration of a vehicle to which a steering control device for a vehicle according to the embodiment is applied, with reference to FIG. 1.

FIG. 1 is a schematic diagram showing a configuration of the vehicle. FIG. 1 is the schematic diagram of the vehicle observed from above. The left shows the front of the vehicle, and the right shows the rear of the vehicle. Additionally, the broken arrow shows the input/output of the signal.

The vehicle mainly includes an engine 1, front wheels 2fR and 2fL, rear wheels 2rR and 2rL, a front wheel steering shaft 3f, a rear wheel steering shaft 3r, a handle (steering wheel) 4, a handle (steering wheel) angle sensor 5, a vehicle speed sensor 6, a front wheel steer actuator 7f, a rear wheel steer actuator 7r and a system controller 10. Hereinafter, as for the symmetrically-arranged components, “R” and “L” are applied to the reference numerals when it is necessary to discriminate the right from the left, and “R” and “L” are omitted when it is not necessary to discriminate the right from the left.

The engine 1 is the internal combustion engine which combusts the mixture in the combustion chamber and generates the power. The power generated by the engine 1 is transmitted to the front wheels 2f and/or the rear wheels 2r via a torque converter, a transmission and a drive shaft, which are not shown.

The steering angle of the front wheels 2f is controlled by the front wheel steer actuator 7f via the front wheel steering shaft 3f. The steering angle of the rear wheels 2r is controlled by the rear wheel steer actuator 7r via the rear wheel steering shaft 3r. Namely, the steering angles of the front wheels 2f and the rear wheels 2r are independently controlled, respectively (in other words, they are separately steered). Thus, the vehicle is formed so that the four wheels can be steered.

The handle 4 is operated by the driver for turning the vehicle, and the steering power by the driver is transmitted to the front wheel steer actuator 7f via the steering shaft. The angle of the handle 4 (namely, handle angle) rotated by the driver is detected by the handle angle sensor 5. The handle angle sensor 5 provides the system controller 10 with the detecting signal S1 corresponding to the detected handle angle. Additionally, the vehicle speed sensor 6 detects the speed of the vehicle (the vehicle speed) and provides the system controller 10 with the detecting signal S2 corresponding to the detected vehicle speed.

The front wheel steer actuator 7f and the rear wheel steer actuator 7r correspond to the steering control unit in the present invention, and are formed to be able to control the steering angle of the front wheels 2f and the steering angle of the rear wheels 2r, respectively. Concretely, the front wheel steer actuator 7f and the rear wheel steer actuator 7r control the steering angle of the front wheels 2f and the steering angle of the rear wheels 2r via the front wheel steering shaft 3f and the rear wheel steering shaft 3r, in accordance with the control signal S3f and the control signal S3r provided by the system controller 10, respectively. In details, the front wheel steer actuator 7f and the rear wheel actuator steer 7r perform the control so that the front wheels 2f and the rear wheels 2r are steered at the steering angle corresponding to the control signal S3f and the control signal S3r provided by the system controller 10, respectively.

The system controller 10 is formed by the so-called ECU (Electronic Control Unit), and includes a CPU, a ROM, a RAM, an A/D converter and an input/output interface. In the embodiment, the system controller 10 performs the steering control of the front wheels 2f and the rear wheels 2r via the front wheel steer actuator 7f and the rear wheel steer actuator 7r, based on the handle angle (corresponding to the detecting signal S1) obtained by the handle angle sensor 5 and the vehicle speed (corresponding to the detecting signal S2) obtained by the vehicle speed sensor 6. The system controller 10 functions as the phase control unit and the setting unit in the present invention, which will be described in details, later.

### [Steering Control Method]

Next, a description will be given of the steering control method performed by the system controller 10 in the embodiment. In the embodiment, the system controller 10 performs the control of the front wheel steer actuator 7f and the rear wheel steer actuator 7r so as to control a phase difference between a yaw rate and a lateral acceleration at a predetermined position in a vehicle interior. Concretely, the system controller 10 performs the steering control so that the phase difference between the yaw rate and the lateral acceleration at the predetermined position in the vehicle interior becomes a desired phase difference. For example, the system controller 10 performs the steering control so that the phase of the lateral acceleration precedes the phase of the yaw rate at the predetermined position. As an example, the system controller 10 selects a prepared control map or control law for performing the steering control so that the phase of the lateral acceleration precedes the phase of the yaw rate at the predetermined position, and performs the steering control.

Additionally, the system controller 10 sets the above predetermined position based on a riding position condition of passengers in the vehicle interior. For example, the system controller 10 uses a presence or absence of the passenger on the rear seat as the riding position condition, and sets the predetermined position to the rear seat side when the passenger is present on the rear seat. Meanwhile, the system controller 10 sets the predetermined position to the front seat side (namely, the driver seat side) when the passenger is not present on the rear seat. The presence or absence of the passenger on the rear seat is used as the riding position condition as described above, because the driver basically rides on the driver seat and it can be said that it is only necessary to determine the presence or absence of the passenger on the rear seat, as the riding position condition of the passengers in the vehicle interior.

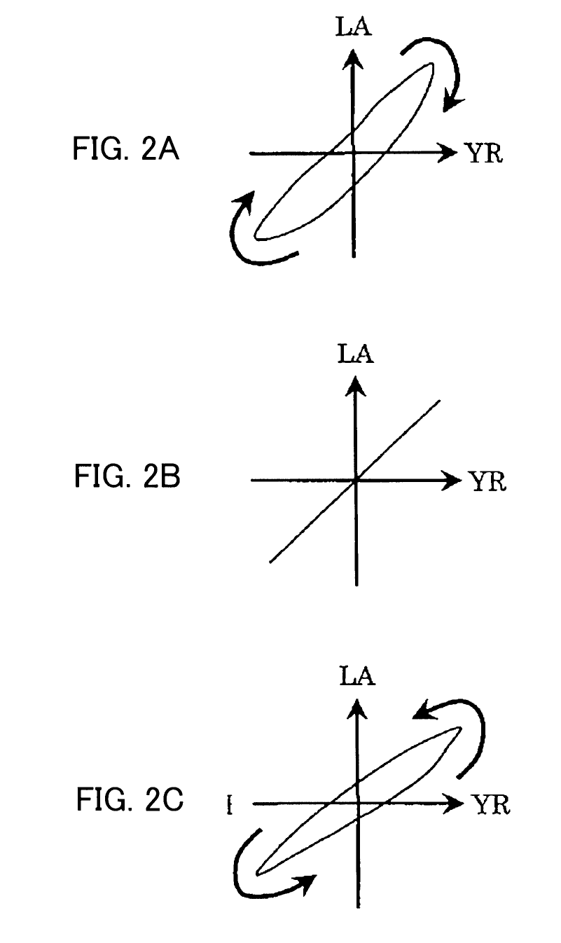

Here, a description will be given of the reason for performing the above steering control, with reference to FIGS. 2A to 2C. FIGS. 2A to 2C show examples of the phase difference between the lateral acceleration and the yaw rate which occurs in the vehicle in case of performing the steering control at the time of performing the predetermined handle operation. Basically, when the steering control (four-wheel steering) is performed, as shown in FIGS. 2A to 2C, for example, the phase difference between the lateral acceleration and the yaw rate can freely be set. In FIGS. 2A to 2C, the lateral acceleration is referred to as “LA”, and the yaw late is referred to as “YR”.

Concretely, FIG. 2A shows a graph in such a case that the phase of the lateral acceleration precedes the phase of the yaw rate. FIG. 2B shows a graph in such a case that there is almost no phase difference between the lateral acceleration and the yaw rate. FIG. 2C shows a graph in such a case that the phase of the yaw rate precedes the phase of the lateral acceleration.

At the time of a low speed, if the relationship between the lateral acceleration and the yaw rate on the driver seat becomes the relationship as shown in FIG. 2B or FIG. 2c, the driver tends to feel uncomfortable like “spinning top” or “coffee cup (in amusement parks)”. Therefore, in general, at the time of the low speed, the steering control is performed (namely, the tuning is performed) so that the relationship between the lateral acceleration and the yaw rate on the driver seat becomes the relationship as shown in FIG. 2A. However, even if the relationship on the driver seat becomes the relationship as shown in FIG. 2A, the relationship between the lateral acceleration and the yaw rate on the rear seat in the normal passenger vehicle tends to become the relationship as shown in FIG. 2B or FIG. 2c. This is because the lateral acceleration which transiently occurs in the vehicle tends to vary with the position in the longitudinal (front-back) direction of the vehicle. Therefore, in this case, even if the driver sitting on the driver seat does not feel uncomfortable, the passenger sitting on the rear seat sometimes feels uncomfortable. Or, even if the passenger sitting on the rear seat does not feel uncomfortable, the driver sitting on the driver seat sometimes feels uncomfortable.

So, in the embodiment, the steering control is performed in consideration of the above fact that the phase difference between the yaw rate and the lateral acceleration is different between the driver seat and the rear seat. Concretely, the system controller 10 selects the position (concretely, the driver seat or the rear seat) at which the relationship (phase difference) between the lateral acceleration and the yaw rate is emphasized in the vehicle interior, based on a driver's intention, a driving mode and the presence or absence of the passenger on the rear seat, for example, and the system controller 10 performs the steering control so that the passenger at the selected position does not feel uncomfortable. In details, the system controller 10 performs the steering control so that the phase difference between the yaw rate and the lateral acceleration at the above selected position becomes the desired phase difference. In more details, the system controller 10 performs the steering control so that the phase of the lateral acceleration precedes the phase of the yaw rate at the above selected position (namely, the relationship between the lateral acceleration and the yaw rate becomes the relationship as shown in FIG. 2A).

Additionally, at the time of such a low speed that the vehicle speed is equal to or smaller than a predetermined speed (for example, the vehicle speed is equal to or smaller than 40 [km/h]), the system controller 10 performs the above steering control. This is because, at the time of the low speed, the phase difference between the yaw rate and the lateral acceleration tends to have a significant influence on the passenger.

By the above steering control method according to the embodiment, it becomes possible to appropriately ensure the comfort (namely, ride quality) of the driver and/or the passenger on the rear seat.

Hereinafter, a concrete description will be given of embodiments of the steering control method performed by the system controller 10.

### First Embodiment

In a first embodiment, at the time of the low speed, the system controller 10 selects the position (the driver seat or the rear seat) at which the relationship (phase difference) between the lateral acceleration and the yaw rate is prioritized, and performs the steering control so that the passenger at the selected position does not feel uncomfortable. Concretely, the system controller 10 performs the steering control so that the phase of the lateral acceleration precedes the phase of the yaw rate at the selected position.

In details, the system controller 10 determines the position where the relationship between the lateral acceleration and the yaw rate is prioritized in the vehicle interior, based on the presence or absence of the passenger on the rear seat. In this case, when the passenger is not present on the rear seat, the system controller 10 determines the driver seat as the position where the relationship between the lateral acceleration and the yaw rate is prioritized. Meanwhile, when the passenger is present on the rear seat, the system controller 10 determines the rear seat as the position where the relationship between the lateral acceleration and the yaw rate is prioritized. Then, the system controller 10 performs the steering control so that the passenger at the above determined position does not feel uncomfortable. For example, the system controller 10 obtains detecting signals from a rear seatbelt sensor and a rear seat pressure sensor installed in the vehicle, and determines the presence or absence of the passenger on the rear seat based on the detecting signals.

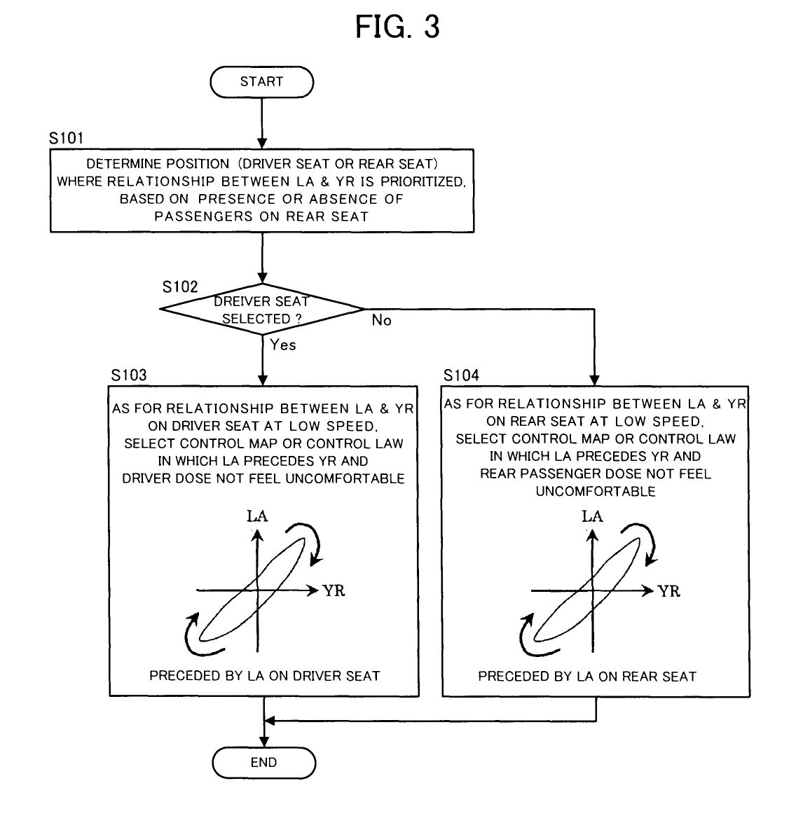

FIG. 3 is a flow chart showing a control process according to the first embodiment. This process is performed by the system controller 10. In FIG. 3, the lateral acceleration is referred to as “LA”, and the yaw late is referred to as “YR”.

In step S101, the system controller 10 determines the position in the vehicle interior where the relationship between the lateral acceleration and the yaw rate is prioritized at the time of the low speed. Concretely, the system controller 10 selects the driver seat or the rear seat based on the presence or absence of the passenger on the rear seat. In details, the system controller 10 determines the presence or absence of the passenger on the rear seat based on the detecting signals from the rear seatbelt sensor and the rear seat pressure sensor. When the passenger is not present on the rear seat, the system controller 10 selects the driver seat. Meanwhile, when the passenger is present on the rear seat, the system controller 10 selects the rear seat. Then, the process goes to step S102.

In step S102, the system controller 10 determines whether or not the driver seat is selected as the position where the relationship between the lateral acceleration and the yaw rate is prioritized. When the driver seat is selected (step S102; Yes), the process goes to step S103. In step S103, as for the relationship between the lateral acceleration and the yaw rate on the driver seat at the time of the low speed, the system controller 10 selects the control map or the control law in which the phase of the lateral acceleration precedes the phase of the yaw rate and the driver does not feel uncomfortable. Namely, the system controller 10 performs the steering control so that the relationship between the lateral acceleration and the yaw rate on the driver seat becomes the relationship as shown in step S103 in FIG. 3. Then, the process ends.

In contrast, when the driver seat is not selected (step S102; No), namely, when the rear seat is selected as the position where the relationship between the lateral acceleration and the yaw rate is prioritized, the process goes to step S104. In step S104, as for the relationship between the lateral acceleration and the yaw rate on the rear seat at the time of the low speed, the system controller 10 selects the control map or the control law in which the phase of the lateral acceleration precedes the phase of the yaw rate and the passenger on the rear seat does not feel uncomfortable. Namely, the system controller 10 performs the steering control so that the relationship between the lateral acceleration and the yaw rate on the rear seat becomes the relationship as shown in step S104 in FIG. 3. Then, the process ends.

By the above-mentioned process, it becomes possible to appropriately determine the position where the relationship between the lateral acceleration and the yaw rate is prioritized, based on the presence or absence of the passenger on the rear seat, and appropriately ensure the comfort of the passenger at the position.

It is preferable that the position where the relationship between the lateral acceleration and the yaw rate is prioritized in the vehicle interior is not immediately switched, even if the detecting signals obtained from the rear seatbelt sensor and the rear seat pressure sensor change while the vehicle is moving. For example, it is preferable that the switching is performed predetermined time after the detecting signals obtained from the rear seatbelt sensor and the rear seat pressure sensor change, or the switching is performed when the vehicle speed becomes approximately “0”. This is to prevent the incorrect determination of the presence or absence of the passenger on the rear seat due to a temporary release of the seatbelt and/or a jump on the seat while the vehicle is moving.

### Second Embodiment

Next, a description will be given of a second embodiment. The second embodiment is different from the first embodiment in that the position where the relationship between the lateral acceleration and the yaw rate is prioritized in the vehicle interior is determined based on the driver's intention (namely, the above predetermined position is determined based on the driver's intention). Namely, in the second embodiment, after the position where the relationship between the lateral acceleration and the yaw rate is prioritized in the vehicle interior is determined based on the presence or absence of the passenger on the rear seat as described above, the position is changed based on the driver's intention.

Concretely, in the second embodiment, the driver selects the position where the relationship between the lateral acceleration and the yaw rate is prioritized, and the steering control is performed so that the passenger at the position selected by the driver does not feel uncomfortable. In this case, by operating a manual switch installed in the vehicle interior, for example, the driver switches the position where the relationship between the lateral acceleration and the yaw rate is prioritized, between the driver seat and the rear seat.

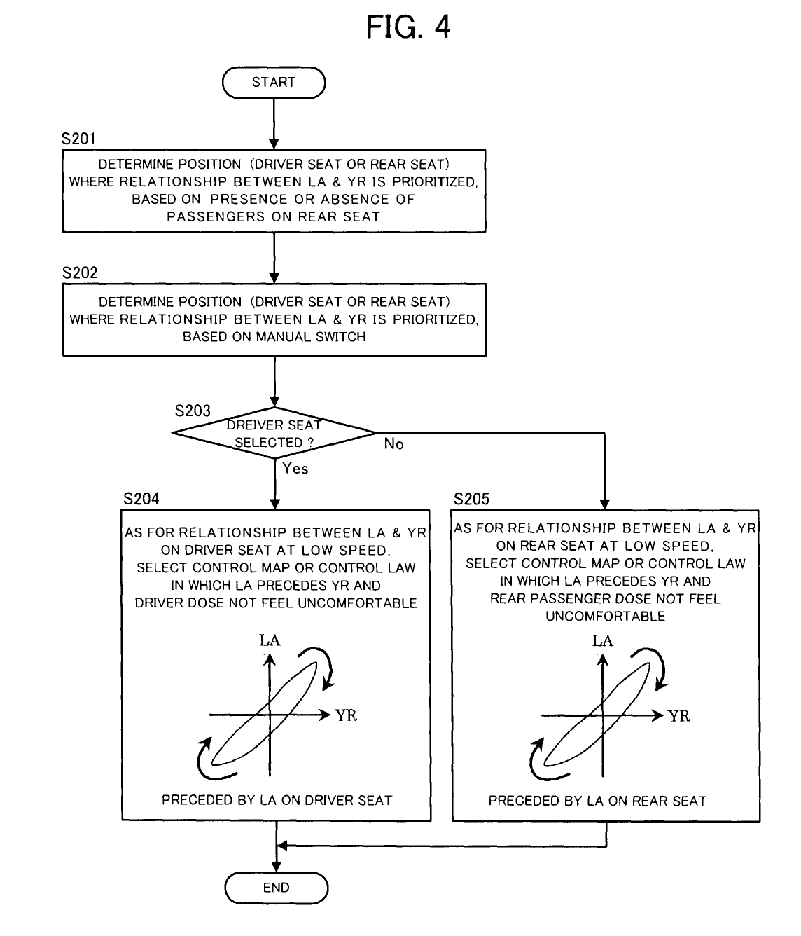

FIG. 4 is a flow chart showing a control process according to the second embodiment. This process is performed by the system controller 10. In FIG. 4, the lateral acceleration is referred to as “LA”, and the yaw late is referred to as “YR”. Additionally, since the process in step S201 and the processes in steps S203 to S205 are similar to the process in step S101 and the processes in steps S102 to S104 as described above (see FIG. 3), explanations thereof are omitted. Here, a description will only be given of a process in step S202.

In step S202, the system controller 10 determines the position in the vehicle interior where the relationship (phase difference) between the lateral acceleration and the yaw rate is prioritized at the time of the low speed. Here, in accordance with the driver's intention, the system controller 10 changes the position (either the driver seat or the rear seat) determined in step S201 based on the presence or absence of the passenger on the rear seat. Concretely, the system controller 10 selects the driver seat or the rear seat in accordance with a setting condition of the manual switch by the operation of the driver. Then, the process goes to step S203.

By the above-mentioned process, it becomes possible to appropriately ensure the comfort of the passenger at the position selected by the driver's intention.

In the above embodiment, while such an example that the position where the relationship (phase difference) between the lateral acceleration and the yaw rate is prioritized in the vehicle interior is determined based on both the presence or absence of the passenger on the rear seat and the driver's intention is shown, it is not limited to this. As another example, the position where the relationship between the lateral acceleration and the yaw rate is prioritized can be determined only based on the driver's intention.

### Third Embodiment

Next, a description will be given of a third embodiment. The third embodiment is different from the first and second embodiments in that the position where the relationship between the lateral acceleration and the yaw rate is prioritized in the vehicle interior is determined based on the driving mode (namely, the above predetermined position is determined based on the driving mode). Namely, in the third embodiment, after the position where the relationship between the lateral acceleration and the yaw rate is prioritized in the vehicle interior is determined based on the presence or absence of the passenger on the rear seat as described above, the position is changed based on the driving mode. Concretely, in the third embodiment, the system controller 10 determines the position where the relationship between the lateral acceleration and the yaw rate is prioritized in accordance with the driving mode set by the driver, and performs the steering control so that the passenger at the position does not feel uncomfortable.

For example, when the driving mode is set to “SPORT”, the system controller 10 determines the driver seat as the position where the relationship between the lateral acceleration and the yaw rate is prioritized. Meanwhile, when the driving mode is set to “NORMAL”, the system controller 10 determines the rear seat as the position where the relationship between the lateral acceleration and the yaw rate is prioritized. By operating a switch (hereinafter referred to as “driving mode changing switch”) in an AVS (Adaptive Variable Suspension System), for example, the driving mode is switched between “SPORT” and “NORMAL”.

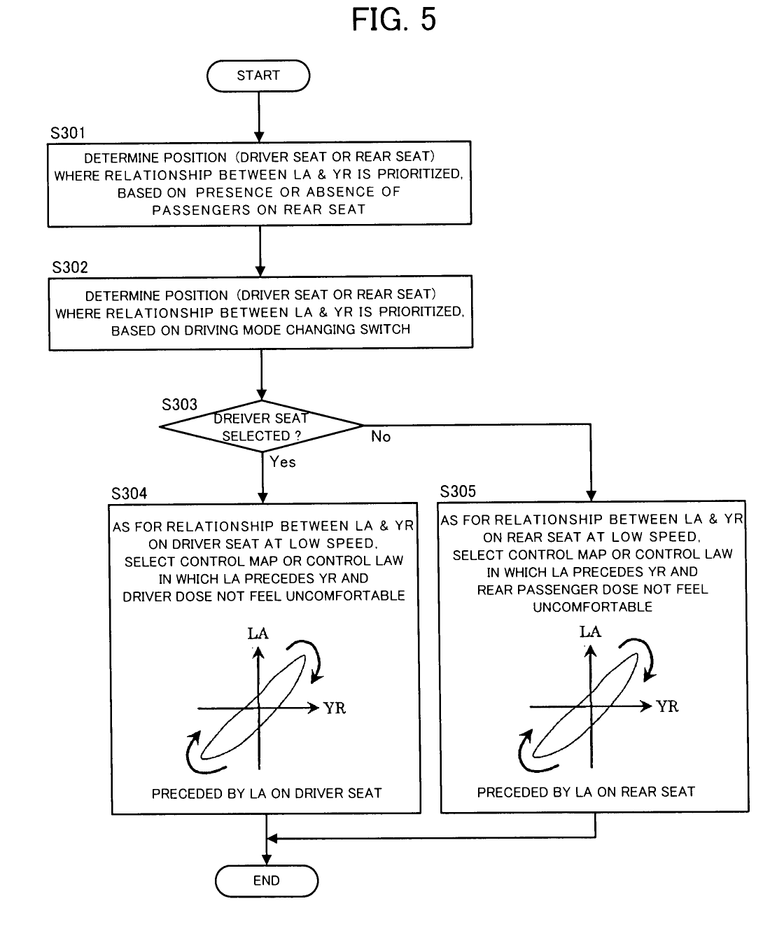

FIG. 5 is a flowchart showing a control process according to the third embodiment. This process is performed by the system controller 10. In FIG. 5, the lateral acceleration is referred to as “LA”, and the yaw late is referred to as “YR”. Additionally, since the process in step S301 and the processes in steps S303 to S305 are similar to the process in step S101 and the processes in steps S102 to S104 as described above (see FIG. 3), explanations thereof are omitted. Here, a description will only be given of a process in step S302.

In step S302, the system controller 10 determines the position in the vehicle interior where the relationship (phase difference) between the lateral acceleration and the yaw rate is prioritized at the time of the low speed. Here, in accordance with the driving mode, the system controller 10 changes the position (either the driver seat or the rear seat) determined in step S301 based on the presence or absence of the passenger on the rear seat. Concretely, the system controller 10 selects the driver seat or the rear seat in accordance with the set driving mode (in other words, a setting condition of the driving mode changing switch by the operation of the driver). In details, when the driving mode is set to “SPORT”, the system controller 10 selects the driver seat. Meanwhile, when the driving mode is set to “NORMAL”, the system controller 10 selects the rear seat. Then, the process goes to step S303.

By the above-mentioned process, it becomes possible to appropriately determine the position where the relationship between the lateral acceleration and the yaw rate is prioritized based on the driving mode and appropriately ensure the comfort of the passenger at the position.

In the above embodiment, while such an example that the position where the relationship (phase difference) between the lateral acceleration and the yaw rate is prioritized in the vehicle interior is determined based on both the presence or absence of the passenger on the rear seat and the driving mode is shown, it is not limited to this. As another example, the position where the relationship between the lateral acceleration and the yaw rate is prioritized can be determined only based on the driving mode. As still another example, the position where the relationship between the lateral acceleration and the yaw rate is prioritized can be determined based on the driving mode and the driver's intention as shown in the second embodiment.

### INDUSTRIAL APPLICABILITY

This invention can be used for a vehicle capable of independently controlling a steering angle of front wheels and a steering angle of rear wheels.

1. A steering control device for a vehicle comprising:
a steering control unit which independently performs a steering control of front wheels and rear wheels;
a phase control unit which performs a control of the steering control unit so as to control a phase difference between a yaw rate and a lateral acceleration at a predetermined position in a vehicle interior; and
a setting unit which sets the predetermined position based on a riding position condition of passengers in the vehicle interior.

2. The steering control device for the vehicle according to claim 1,
wherein the phase control unit performs the control so that a phase of the lateral acceleration precedes a phase of the yaw rate at the predetermined position.

3. The steering control device for the vehicle according to claim 1,
wherein the setting unit obtains a presence or absence of the passenger on a rear seat as the riding position condition, and the setting unit sets the predetermined position to the rear seat side when the passenger is present on the rear seat, and sets the predetermined position to a front seat side when the passenger is not present on the rear seat.

4. The steering control device for the vehicle according to claim 1,
wherein the setting unit sets the predetermined position based on a setting condition of a switch in the vehicle interior by an operation of a driver.

5. The steering control device for the vehicle according to claim 1,
wherein, when a vehicle speed is equal to or smaller than a predetermined speed, the phase control unit controls the phase difference.
